(19) United States
(12) Patent Application Publication
(10) Pub. No.: US 2021/0090078 A1
(43) Pub. Date: Mar. 25, 2021

(54) SYSTEMS AND METHODS FOR AUTHENTICATION BASED ON USER ACTIVITY

(71) Applicant: Wells Fargo Bank, N.A., San Francisco, CA (US)

(72) Inventors: Jay M. Bozicevich, Golden Valley, MN (US); Jonathan E. Hoveland, Charlotte, NC (US); Michael Tilaro, San Francisco, CA (US); Tiffany Twilley, Foster City, CA (US)

(21) Appl. No.: 15/041,913

(22) Filed: Feb. 11, 2016

Related U.S. Application Data
(60) Provisional application No. 62/272,343, filed on Dec. 29, 2015.

(51) Int. Cl. G06Q 20/40

(52) U.S. Cl. CPC G06Q 20/40

(57) ABSTRACT

A financial institution computing system includes a network circuit exchanging information over a network, a customer database storing financial information for a plurality of customers, a user activity circuit, and a transaction circuit. The user activity circuit receives activity data over the network that is indicative of an activity of an authorized user of the financial account specified in a transaction request. The transaction circuit receives a transaction request over the network specifying a financial account. The transaction circuit authenticates the transaction request by determining that the activity data is indicative of an expected activity associated with a characteristic of the transaction request. The transaction circuit authorizes the transaction request based at least in part on whether the transaction request is authenticated and information in the customer database. The transaction circuit is configured to transmit a confirmation to a transaction terminal over the network via the network circuit.

### CROSS-REFERENCE TO RELATED APPLICATIONS

This application claims the benefit of priority to U.S. Provisional Application No. 62/272,343, filed Dec. 29, 2015, which is hereby incorporated by reference in its entirety.

### BACKGROUND

Financial institution customers are able to complete financial transactions in various ways, such as swiping or dipping a payment card at a transaction terminal or by using a computing device, such as a personal computer or mobile device. For example, customers may conduct transactions at a brick and mortar location or over the phone or internet. At the same time, monitoring devices may be located at brick and mortar locations, in the customer's home, or worn by the customer. Furthermore, most people carry some type of mobile handheld electronic device with a wireless internet connection and a variety of sensors including those with motion sensing capabilities and GPS capabilities. Such monitoring devices and mobile handheld electronic devices may acquire information regarding activities of a customer of a financial institution.

### SUMMARY

One embodiment relates to a financial institution computing system. The system includes a network circuit enabling the financial institution computing system to exchange information over a network. The financial institution computing system further includes a customer database storing financial information for a plurality of customers, a user activity circuit, and a transaction circuit. The user activity circuit is configured to receive, over the network via the network circuit, activity data indicative of an activity of an authorized user of the financial account specified in a transaction request. The transaction circuit is configured to receive, over the network via the network circuit, the transaction request specifying a financial account. The transaction circuit is further configured to authenticate, using the activity data, the transaction request by determining that the activity data is indicative of an expected activity associated with a characteristic of the transaction request. The transaction circuit is further configured to authorize the transaction request based at least in part on whether the transaction request is authenticated and information in the customer database. The transaction circuit is further configured to transmit a confirmation to a transaction terminal over the network via the network circuit.

Another embodiment relates to a method of authorizing transaction requests performed by a financial institution computing system. The method includes receiving, by a transaction circuit over a network via a network circuit, a transaction request specifying a financial account. The method further includes receiving, by a user activity circuit over the network via the network circuit, activity data indicative of an activity of an authorized user of the financial account specified in the transaction request. The method further includes authenticating, by the transaction circuit, using the activity data, the transaction request by determining that the activity data is indicative of an expected activity associated with a characteristic of the transaction request. The method further includes authorizing, by the transaction circuit, the transaction request based at least in part on whether the transaction request is authenticated and information in the customer database. The method further includes transmitting, by the transaction circuit via the network circuit, a confirmation to a transaction terminal over the network via the network circuit

Another embodiment relates to non-transitory computer readable media having computer-executable instructions embodied therein that, when executed by a transaction circuit of a financial institution computing system, causes the financial institution computing system to perform operations to authorize transaction requests. The operations include receiving, over a network via a network circuit, a transaction request specifying a financial account. The operations further include receiving, over the network via the network circuit, activity data indicative of an activity of an authorized user of the financial account specified in the transaction request. The operations further include authenticating, using activity data received by an activity circuit over the network via the network circuit, the transaction request by determining that the activity data is indicative of an expected activity associated with a characteristic of the transaction request. The operations further include authorizing the transaction request based at least in part on whether the transaction request is authenticated and information in the customer database. The operations further include transmitting, via the network circuit, a confirmation to a transaction terminal over the network.

### BRIEF DESCRIPTION OF THE FIGURES

FIG. 1 is a block diagram illustrating a transaction request authorizing system, according to an example embodiment.

FIG. 2 is a block diagram illustrating an example embodiment of the transaction request authorizing system shown in FIG. 1.

FIG. 3 is a flowchart of a method of authorizing a transaction request, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting. For example, the embodiments of systems and methods discussed herein may be relevant to any of a variety of circumstances where using characteristics, activities, movements, or other information of a customer of a financial institution to authenticate a transaction may be useful.

Embodiments of systems and methods for authorizing a transaction based on user activity are discussed below. A financial institution computer system receives activity data indicative of an activity of an authorized customer or user of a financial institution. For example, the activity data may be indicative of a previous or current activity of the user leading up to or during when the financial institution receives a transaction request involving an account associated with the user. For example, the activity data may indicate that the user was previously or is currently walking, running, swimming, lifting weights, sitting, sleeping, showering, and so on. The financial institution computer system may receive other types of data relating to the user, such as location data indicative of a location of the user, and biometric data indicative of a biometric characteristic or physiological state of the user (e.g., rate of breathing, body temperature, pulse, etc.). The financial institution computer system also receives a transaction request from a transaction terminal that specifies a financial account. The financial institution computing system may authenticate the transaction request by determining whether the activity data (and/or other types of data) is indicative of an expected activity associated with a characteristic of the transaction request. The financial institution computing system authorizes the transaction and transmits a confirmation to the transaction terminal indicating that the transaction request has been authorized. As such, a non-authorized individual in possession of an authorized user's payment methodology is not able to make fraudulent transactions if the activity of the authorized user does not make sense (e.g., the activity of the user is not the same as or substantially similar to an expected activity) in the context of the transaction. For example, a transaction is not authenticated and authorized if a transaction request is received from an exercise facility but the activity data indicates that the authorized user is actually asleep at the time of the transaction request.

The embodiments and implementations of the systems and methods disclosed herein improve current transaction systems and computing systems for authenticating payment transactions by authenticating transaction requests by determining whether an activity of a user is an expected activity based on a characteristic of the transaction request. These systems, methods, and computer implementations improve the accuracy of authentication procedures by ensuring that an activity of an authorized user prior to or concurrent with a transaction request is commensurate with an activity that would be expected based on the context in which the transaction request is made. As such, the systems, methods, and computer implementations disclosed herein improve the functioning of transaction systems and computing systems for authenticating payment transactions by providing functionalities that are novel and non-obvious improvements over current systems.

The embodiments discussed herein may be relevant to any of a variety of circumstances where an exchange of authenticated payment credentials may be useful. For example, in one embodiment, activity data associated with an authorized user may be used in the context of authenticating and authorizing a purchase transaction at a brick and mortar retail establishment. In another embodiment, the activity data may be used in the context of authenticating and authorizing electronic payment transactions (e.g., person-to-person (“P2P”) transactions, online shopping, etc.).

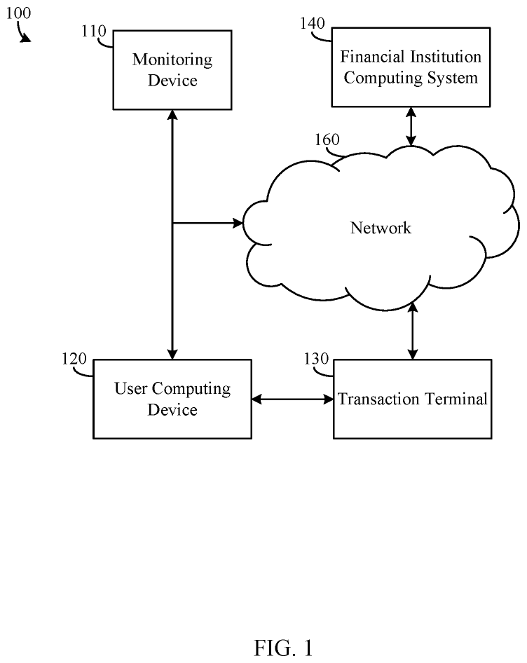

Referring to FIG. 1, a block diagram illustrating a transaction request authorizing system 100 is shown according to an example embodiment. The transaction request authorizing system 100 includes a monitoring device 110, a user computing device 120, a transaction terminal 130, and a financial institution computing system 140. Various components of the system 100 may be configured to communicate with each other over a network 160. The network 160 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments, the network 160 includes the internet.

The monitoring device 110 is a device configured to monitor an authorized user of an account at a financial institution. The monitoring device 110 may include any type of equipment capable of acquiring information regarding the activities of an authorized user, such as location information, movement information, biometric information, a physiological characteristic of the user, and so on. The monitoring device 110 may include a computing device, a smartphone, a camera, a radar, a microphone, proximity sensors, GPS sensors, gyroscopes, among other monitoring device types and sensors. In some embodiments, the monitoring device 110 is configured to be worn by the authorized user. For example, the monitoring device 110 may be a smartwatch or include a clothing-embedded sensor. The monitoring device 110 is configured to exchange information with the user computing device 120 and the financial institution computing system 140. For example, the monitoring device 110 may be configured to transmit activity data of an authorized user to the financial institution computing system 140 over the network 160 based on a schedule (e.g., every five minutes, etc.), based on a particular type of data being acquired regarding the authorized user (e.g., data indicative of the user sleeping, walking above a time duration threshold, walking or running above a particular pace, etc.), or based on the financial institution computing system 140 receiving a transaction request from the transaction terminal 130. In some embodiments, the monitoring device 110 is configured to receive an input from the authorized user or provide an output to the authorized user (e.g., based on the user's activity information, based on the financial institution computing system 140 receiving a transaction request, etc.). In some embodiments, the user computing device 120 is the monitoring device 110 and no additional monitoring devices are used (e.g., if the user computing device 120 is a smartphone, an additional monitoring device is not required but may be used by the system 100 to monitor the user).

The user computing device 120 is a computing system associated with an authorized user of one or more financial accounts at the financial institution. The user computing device 120 includes one or more processors and non-transitory storage mediums housing one or more logics configured to enable the user computing device 120 to exchange data over the network 160, execute software applications, access websites, generate graphical user interfaces, and perform other similar operations. Examples of the user computing device 120 include a personal computer such as a desktop or laptop computer, smartphones, tablets, wearable computing devices such as smartwatches, and the like. In some embodiments, the user computing device 120 is or includes a smart payment card. In some embodiments, the user computing device 120 may communicate with an additional device used to authenticate the user such as a smartwatch, a pedometer, a key fob, and the like. As such, the user computing device 120 may be configured to cooperate with the additional device to prepare and transmit transaction information that is ultimately received at the financial institution computing system 140.

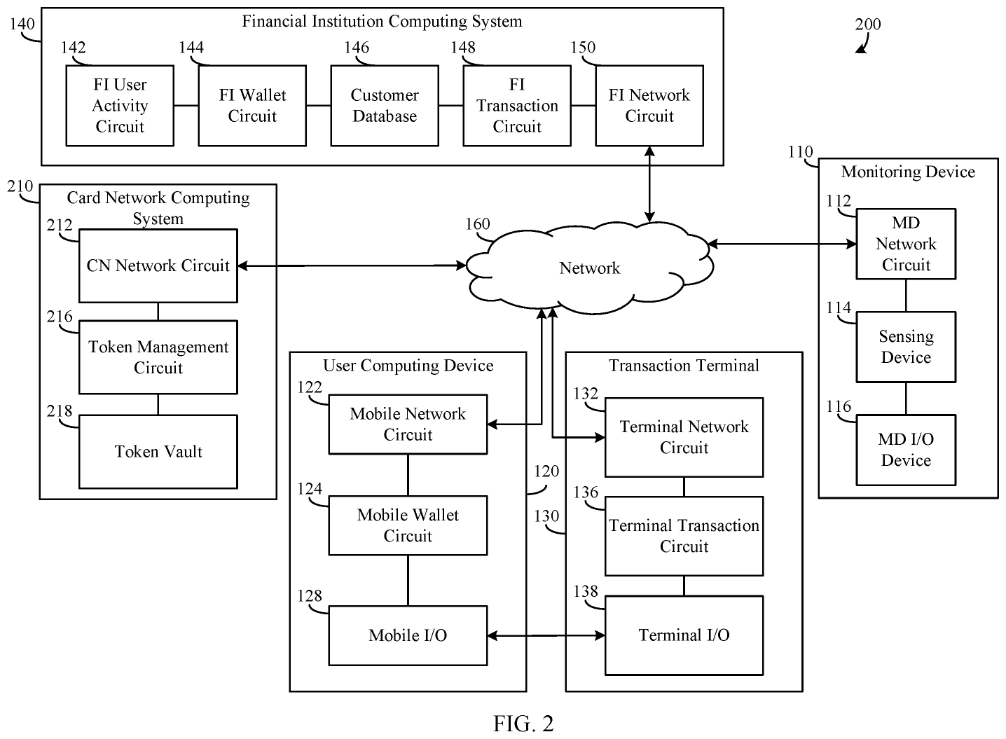

In some embodiments, the user computing device 120 is configured to manage at least one payment credential corresponding to a method of payment associated with the user. For example, the user computing device 120 may include one or more circuits configured to provide the user with a mobile wallet, as discussed in more detail below with respect to FIG. 2. In some embodiments, in preparing transaction information, the mobile device includes payment credentials corresponding to a method of payment. The user computing device 120 may then transmit the transaction information to the transaction terminal 130.

The transaction terminal 130 is a computing system associated with an individual or entity with whom a user seeks to transact (e.g., merchants, service providers, etc.). The transaction terminal 130 is configured to receive transaction information from the user computing device 120 and create a transaction request that is transmitted to the financial institution computing system 140. The transaction request may be a request for the financial institution computing system 140 to withdraw a designated sum of funds from a financial account corresponding to the transaction information and deposit the designated sum of funds into an account associated with the requesting party (e.g., an individual or entity associated with the transaction terminal 130). The transaction request may be a request for the financial institution computing system 140 to debit a financial account corresponding to the transaction information and credit an account associated with the requesting party. For example, the transaction terminal 130 may include merchant point of sale terminals, ATMs, one or more servers configured to process online or P2P transactions, and so on.

The financial institution computing system 140 is a computing system at a financial institution that is capable of maintaining customer accounts (e.g., payment card accounts) and databases of customer information. The financial institution may include commercial or private banks, credit unions, investment brokerages, or the like. In response to a received transaction request, the financial institution computing system 140 may be configured to authenticate the transaction information, and authorize the transaction request (e.g., determining whether the identified financial account contains sufficient funds, and transferring the designated sum of funds to an identified account). The financial institution computing system 140 may be configured to transmit a message back to the transaction terminal 130 indicating whether the transaction request was approved or denied.

Referring now to FIG. 2, a transaction system 200 is shown as a more detailed embodiment of the system 100 and further including a card network computing system 210. The system 200 includes example embodiments of the authentication device 102, the mobile device 104, the transaction terminal 106, the network 108, and the financial institution computing system 110 of FIG. 1.

The card network computing system 210 is a computing system associated with a card network. Examples of card networks include Visa®, MasterCard®, etc. The card network computing system 210 performs operations associated with the generation and issuance of payment card tokens. Payment card tokens are surrogate values that replace the primary account number (“PAN”) associated with a payment card, such as a credit card, debit card, ATM card, stored value card, etc. Payment card tokens may pass basic validation rules of an account number. For example, in the case of a debit card, the payment card token for a given debit card may “look like” a real debit card number (e.g., a sixteen-digit number), but in fact is only a token. As part of a token generation process, steps are taken such that the generated payment card token does not have the same value as or otherwise conflicts with a real PAN (e.g., a real debit card number). A given payment card token may be provisioned to various locations for use in various types of scenarios, including ATMs for performing various financial operations, storage at a mobile device (e.g., a smartphone) for in-person or on-line transactions with a merchant, and so on.

The card network computing system 210 includes a card network (“CN”) computing system network circuit 212, a token management circuit 216, and a token vault 218. The CN network circuit 212 enables the card network computing system 210 to exchange data over the network 160. As such, the CN network circuit 212 allows the card network computing system 210 to exchange data to remote computing devices (e.g., the user computing device 120, the transaction terminal 130, the financial institution computing system 140, etc.).

The token management circuit 216 is configured to provision and manage tokens. In one aspect, the token management circuit 216 may generate a new unique code to be provisioned as a token, associate the token with a PAN, and store corresponding mapping data in the token vault 218. In another aspect, the token management circuit 216 may replace tokens as well as activate and deactivate tokens, and update the token vault 218 accordingly. The token management circuit 216 may also be configured to associate permissions with each token, thereby allowing or disallowing the transmission or use of data associated with a given token. The token management circuit 216 may also cause one or more tokens to be disposed on the user computing device 120, for example as discussed with respect to the mobile wallet circuit 124 below.

The token vault 218 is a storage medium maintaining established payment card tokens-to-PAN mapping data. The token vault 218 may include non-transient data storage mediums (e.g., local disc or flash-based hard drives, local network servers, and the like) or remote data storage facilities (e.g., cloud servers).

In the system 200, the monitoring device 110 includes a monitoring device network circuit 112 enabling the monitoring device 110 to exchange data over the network 160, a sensing device 114, and a monitoring device input/output (I/O) device 116. An input aspect of the monitoring device I/O device 116 allows an individual operating the monitoring device 110 to provide information to the monitoring device 110, and may include, for example, a mechanical keyboard, a touchscreen, a microphone, a camera, a fingerprint scanner, any user input device engageable to the monitoring device 110 via a USB, serial cable, Ethernet cable, and so on. An output aspect of the monitoring device I/O device 116 allows an individual associated with the monitoring device 110 or in proximity to the monitoring device 110 to receive information from the monitoring device 110, and may include, for example, a digital display, a speaker, illuminating icons, LEDs, and so on. Further, the monitoring device I/O device 116 may be configured to include assemblies that serve both input and output functions, allowing the financial institution computing system 140 and the user computing device 120 to exchange information with the monitoring device 110. Such assemblies include, for example, radio frequency transceivers (e.g., RF or NFC-based transceivers) and other short-range wireless transceivers (e.g., Bluetooth™, laser-based data transmitters, etc.).

The monitoring device 110 may include a plurality of monitoring devices 110 configured to monitor an authorized user of a financial account. The monitoring devices 110 may include any type of sensing device 124 used to acquire activity data indicative of activities of the authorized user. The monitoring devices 110 may include wearable computing devices and/or may be devices that do not include any capabilities for making or receiving telephone calls using cellular telephone networks. For example, the monitoring devices 110 may include devices not worn or owned by the authorized user, such as structure-mounted devices or satellite systems. The activity data may include location data indicative of a location of the authorized user, and movement data indicative of physical movements of the authorized user. As an example, the monitoring device 110 may include a wearable that is worn around an ankle of the user and monitors activities such as running and walking. As another example, the monitoring device 110 may include a wearable that monitors heart activity (e.g., heart rate, etc.). As another example, the monitoring device 110 may include a device that is not mobile (not carried with the user) when it is utilized. For example, the monitoring device 110 may be a device fixedly mounted inside or outside of a building (e.g., a home security camera or proximity sensor that is fixedly mounted inside a home of the user, a traffic camera, etc.). In various other example embodiments, the sensing device 124 may include a microphone, a motion sensor, a Lidar device, a radar device, an ultrasound device, a blood pressure sensor, a thermometer, a gyroscope, a pitot tube, a piezoelectric sensor, and so on. The sensing device 124 may be a security camera, dashboard camera, motion detector, and the like.

In some embodiments, the activity data may include biometric data indicative of a biometric characteristic or physiological state of the authorized user. The monitoring device 110 may be configured to measure biometric data from the body of the user. The biometric data may include, for example, presence and/or rate of a heartbeat, body temperature, bodily movement, etc. In some embodiments, the monitoring device 110 transmits the activity data to the customer database 146 of the financial institution computing system 140 via the network 160.

In the system 200, the user computing device 120 includes a mobile network circuit 122 enabling the user computing device 120 to exchange data over the network 160, a mobile wallet circuit 124, and a mobile input/output device (“I/O”) 128. The mobile I/O 128 includes hardware and associated logics configured to enable the user computing device 120 to exchange information with a user and the transaction terminal 130 (e.g., via a corresponding terminal I/O 138, as discussed below). An input aspect of the mobile I/O 128 allows the user to provide information to the user computing device 120, and may include, for example, a mechanical keyboard, a touchscreen, a microphone, a camera, a fingerprint scanner, any user input device engageable to the user computing device 120 via a USB, serial cable, Ethernet cable, and so on. An output aspect of the mobile I/O 128 allows the user to receive information from the user computing device 120, and may include, for example, a digital display, a speaker, illuminating icons, LEDs, and so on. The mobile I/O 128 may be configured to include assemblies that serve both input and output functions, allowing the financial institution computing system 140 and the transaction terminal 130 to exchange information with the user computing device 120. Such assemblies include, for example, radio frequency transceivers (e.g., RF or NFC-based transceivers) and other short range wireless transceivers (e.g., Bluetooth™, laser-based data transmitters, etc.).

The mobile wallet circuit 124 is a circuit configured to provide a user with a mobile wallet. The mobile wallet circuit 124 may provide an interface configured to receive and display mobile web pages (e.g., web pages provided on the mobile I/O 128 prompting the user to provide information to create an account, web pages displaying account balance information, past transactions, and so on) received from a mobile wallet bank computer system (e.g., an FI wallet circuit 144 at the financial institution computing system 140 as discussed below, or a third party wallet provider such as ApplePay™ or Android Pay™) over the network 160 via the mobile network circuit 122.

While setting up a mobile wallet account, the mobile wallet circuit 124 may receive, organize, and store payment credentials (e.g., payment tokens) from a payment card (e.g., from local storage disposed on a credit card, debit card, gift card, etc., for example, via functionalities available through EMV smart cards such as Visa payWave™, Mastercard PayPass™, and American Express ExpressPay™) or the card network computing system 210 over the network 160. The mobile wallet circuit 124 may then allow users to choose any one of the accounts for transferring funds, for example, to a merchant for goods or services. A user may also select a default account that the mobile wallet circuit 124 will use to make payments. The user may alternatively use account selection logic at the mobile wallet circuit 124 to select a specific account to use for each transaction.

In some embodiments, the mobile wallet circuit 124 is configured to cooperate with the mobile I/O 128 to prepare transaction information. For example, prior to a transaction, the mobile wallet circuit 124 may be configured to authenticate the user computing device 120. The mobile wallet circuit 124 may then prepare transaction information to include a customer payment token. The mobile wallet circuit 124 may subsequently transmit the transaction information to the transaction terminal 130 via the mobile I/O 128.

The transaction terminal 130 includes a terminal network circuit 132 enabling the transaction terminal 130 to exchange data over the network 160, a terminal transaction circuit 136, and a terminal I/O 138. Similar to the mobile I/O 128, the terminal I/O 138 includes hardware and associated logics configured to enable the transaction terminal 130 to exchange information with a user, the user computing device 120 (e.g., via corresponding hardware and logics at the mobile I/O 128), and a terminal attendant (e.g., a store clerk), if any. The terminal I/O 138 may include any of the input, output, and input/output functionalities discussed with respect to the mobile I/O 128, above.

The terminal transaction circuit 136 is configured to receive transaction information (e.g., including a payment token) from the user computing device 120 via the terminal I/O 138, and assemble corresponding transaction requests. The terminal transaction circuit 136 determines a total transaction amount for a payment transaction (e.g., total price of specified products and/or services, including sales tax, other fees, etc.), bundles the total with the transaction information to make a transaction request, and transmits the transaction request to the financial institution computing system 140 over the network 160 via the terminal network circuit 132.

The financial institution computing system 140 includes a financial institution (“FI”) user activity circuit 142, an FI wallet circuit 144, a customer database 146, an FI transaction circuit 148, and an FI network circuit 150 enabling the financial institution computing system 140 to exchange data over the network 160.

The customer database 146 allows the financial institution computing system 140 to retrievably store customer information relating to the various operations discussed herein, and may include non-transient data storage mediums (e.g., local disc or flash-based hard drives, local network servers, and the like) or remote data storage facilities (e.g., cloud servers). The customer database 146 includes personal customer information (e.g., names, addresses, phone numbers, and so on), identification information (e.g., driver's license numbers, standard biometric data, and so on), and customer financial information (e.g., token information, account numbers, account balances, available credit, credit history, transaction histories, and so on). The customer database 146 includes information relating to a plurality of users who are authorized to make transactions with a plurality of financial accounts (e.g., credit card accounts, checking accounts, etc.). Authorized users may include account owners, or other individuals designated as authorized users by a respective account owner.

The customer database 146 further includes activity information for the various users authorized to make transactions with financial accounts. The customer database 146 may store any information acquired by the monitoring device 110. For example, the customer database 146 may store activity data indicative of a previous or current activity of the user leading up to or during when the financial institution receives a transaction request involving an account associated with the user. The customer database 146 may include location data indicative of a location of the user, and biometric data indicative of a biometric characteristic or physiological state of the user. In some embodiments, for each authorized user, the activity data, biometric data, and the location data are variously associated with one another to create an activity profile. For example, the activity profile may be indicative of typical characteristics of the authorized user, such as a typical walking pace or normal resting heart rate. In some embodiments, the activity profile may associate the activity data with transaction requests or transaction request types. For example, the activity profile may be indicative of typical activities of the authorized user leading up to or concurrent with a particular transaction or transaction type. For example, the activity profile may indicate that whenever the authorized user of an account conducts a transaction at a particular exercise facility, movement data associated with the authorized user leading up to the transaction indicates that the user jogged for twenty minutes, which may indicate that the authorized user typically jogs to the gym or jogs at the gym for twenty minutes before making a purchase there (e.g., to purchase a workout supplement, water, etc.).

The FI user activity circuit 142 enables the financial institution computing system 140 to cooperate with the FI wallet circuit 144 and FI transaction circuit 148 to authorize transactions based on the activity of an authorized user. The FI user activity circuit 142 is configured to receive, over the network 160 via the network circuit 150, activity data indicative of an activity of an authorized user of the financial account specified in a transaction request. In some embodiments, the activity data is indicative of an activity of the authorized user leading up to or concurrent with a transaction request and may be used to automatically authenticate a transaction at the time of purchase. In some embodiments, the activity data is indicative of an activity of the authorized user after a transaction request is received by the financial institution computing system 140 and may be used to authenticate a transaction on a delay after the transaction request is received. In some embodiments, the FI user activity circuit 142 receives the activity data from the user computing device 120 or the monitoring device 110. The user computing device 120 may be a device associated with the authorized user, such a smartphone or other computing device. The monitoring device 110 may be associated with the authorized user or may be configured to acquire activity data for a plurality of individuals in addition to the authorized user of the financial account.

In some embodiments, the FI user activity circuit 142 is configured to determine an expected activity of a user based on a characteristic of the transaction request. The characteristic of the transaction request may include any information about the transaction or merchant where the transaction request originates. The characteristic of the transaction request may include a location of the transaction terminal 130, a time of day when the FI transaction circuit 148 receives the transaction request, a day of the week when the FI transaction circuit 148 receives the transaction request, a type of merchant associated with the transaction terminal 130, a type of transaction, a type of good purchased, a type of service purchased, etc. For example, the FI user activity circuit 142 may determine that walking at a pace of fifty steps per minute is an expected activity of a user prior to conducting a transaction based on the location of the transaction terminal 130 (e.g., if the transaction terminal 130 is located inside of a shopping mall). In another example, the FI user activity circuit 142 may determine that sleeping is an expected activity of the authorized user based on the FI transaction circuit 148 receiving the transaction request at 11:00 pm. In this example, the FI transaction circuit 148 may deny the transaction because if the authorized user is sleeping then the authorized user is likely not attempting to conduct a transaction. In another example, the FI user activity circuit 142 may determine that jogging for at least ten minutes is an expected activity of a user based on the transaction terminal 130 being associated with an exercise facility, such as a gym.

In some embodiments, the activity data is indicative of an activity that the authorized user performs concurrent with the financial transaction request or prior to the financial transaction request. In some embodiments, the activity data is indicative of an activity that the authorized user performs after the financial transaction request is received by the financial institution computing system 140. For example, in some embodiments, a system may analyze the activity data after the transaction request has been authorized or not authorized to determine a likelihood of the transaction being fraudulent. In some embodiments, the transaction circuit 148 may use the activity data to perform a delayed authentication procedure that occurs at a time after the transaction request is received. For example, in some embodiments, after the FI transaction circuit 148 receives a transaction request, the FI user activity circuit 142 receives activity data indicative of the authorized user's activities after the transaction request is received and analyzes the activity data to determine whether activities of the authorized are what would be expected of the authorized user after making the transaction request (e.g., based on a characteristic of the transaction request).

In some embodiments, the FI wallet circuit 144 enables or otherwise supplements the operation of the mobile wallet circuit 124. In some embodiments, the FI wallet circuit 144 is configured to communicate with the mobile wallet circuit 124 over the network 160 (e.g., via respective network circuits 122, 150). A user may establish the mobile wallet circuit 124 on the user computing device 120 and set up a mobile wallet account. In one embodiment, the user may then manually provide a PAN to the mobile wallet circuit 124 via the mobile I/O 128, and the mobile wallet circuit 124 may transmit the PAN to the FI wallet circuit 144 over the network 160 (e.g., via respective network circuits 122, 150). The FI wallet circuit 144 may then route the PAN to the token management circuit 216 over the network 160 for tokenization, receive a payment token in return, and transmit the payment token back to the mobile wallet circuit 124. In some embodiments, the FI wallet circuit 144 automatically tokenizes PAN information associated with the customer in the customer database 146. After the customer sets up the mobile wallet account, the FI wallet circuit 144 may provide tokens corresponding to one or more financial accounts of the customer to the mobile wallet circuit 124. The mobile wallet circuit 124 may then include the payment token in transaction information that is sent as part of transaction requests to the financial institution computing system 140. The FI wallet circuit 144 may also cooperate with the mobile wallet circuit 124 and the token management circuit 216 to manage token permissions, token life cycles, etc.

The FI transaction circuit 148 is configured to facilitate transactions involving the FI user activity circuit 142. The FI transaction circuit 148 may receive a transaction request from the transaction terminal 130 over the network 160 via the FI network circuit 150. In some embodiments, the FI transaction circuit 148 receives the transaction request from the card network computing system 210 (e.g., where payment tokens are used). In one aspect, the FI transaction circuit 148 authenticates the user using information included in the transaction request. In one embodiment, the FI transaction circuit 148 looks up the information in the customer database 146 and confirms whether the information is associated with an authorized user of a financial account. If known information matches the information in the transaction request, the FI transaction circuit 148 may authenticate the transaction request. In some embodiments, the FI transaction circuit 148 may be configured to request additional authentication information from the user (e.g., a PIN, answers to one or more security questions, etc.).

In some embodiments, the FI transaction circuit 148 is configured to authenticate the transaction request using the activity information acquired by the FI user activity circuit 142. The FI transaction circuit 148 may determine that the activity data is indicative of an expected activity associated with a characteristic of the transaction request. For example, the FI transaction circuit 148 may authenticate a transaction request if the transaction request is received from an exercise facility and the activity data indicates that the authorized user is currently jogging. In some instances, the FI transaction circuit 148 may not authenticate the transaction request based on determining that the authorized user is actually asleep at the time of the transaction request and it is therefore not likely that the authorized user is conducting a transaction at an exercise facility.

In some embodiments, the FI transaction circuit 148 determines whether the activity data is indicative of the expected activity by comparing the activity data with previous activity data of the authorized user. The previous activity data of the authorized user may be acquired by the FI user activity 142 in conjunction with a previous transaction request or a series of previous transaction requests. In some embodiments, the FI transaction circuit determines that the activity data is indicative of the expected activity by comparing the activity data to a user profile associated with the authorized user stored in the customer database 146. For example, the FI user activity circuit 142 may store the activity data received by in the customer database 146 to create a user profile for each authorized user. For example, the activity profile may be indicative of typical characteristics of the authorized user, such as a typical walking pace, normal resting heart rate, average breathing patterns when walking or running, average body movements made when sleeping, average mouth movements when eating, a typical pulse when sitting, and other activity patterns of the authorized user.

In another aspect, the FI transaction circuit 148 may perform a series of checks that do not involve the FI user activity circuit 142 before authorizing the transaction request. The FI transaction circuit 148 may perform one or more fraud checks. In addition, the FI transaction circuit 148 may determine whether the transaction request may properly be completed, for example, determining whether the financial account specified in the transaction request contains sufficient funds to cover the purchase price. In one embodiment, if the transaction request passes a plurality of fraud checks and the underlying transaction may properly be completed, the FI transaction circuit 148 authorizes and completes the transaction request.

For example, in some embodiments, the FI transaction circuit 148 may deny a transaction request based on receiving activity data from wearable devices or Internet of Things devices located at an authorized user's home that indicates that authorized user is actually asleep and therefore not likely to be conducting a transaction. In another example, the FI transaction circuit 148 may deny a transaction request based on receiving activity data from sensing devices (e.g., the monitoring device 110) that indicate that the authorized user is likely not asleep, but is rather very sedentary (e.g., if the user is having their morning coffee or is sitting at a desk typing) and is therefore not likely conducting a transaction at a shopping mall (e.g., because the authorized user would likely be walking instead of being in a sedentary state).

In operation according to one embodiment, a user sets up and configures the mobile wallet circuit 124 on the user computing device 120 and uses the mobile wallet circuit 124 in cooperation with the FI wallet circuit 144 to register at least one approved method of payment at the financial institution computing system 140. The user may approach the transaction terminal 130 to purchase a good or service, and tap the user computing device 120 against the terminal I/O 138. The mobile wallet circuit 124 may then prepare transaction information and a payment token. The transaction information may then be transmitted from the mobile I/O 128 to the terminal I/O 138.

The terminal transaction circuit 136 receives and bundles the transaction information with a transaction amount to generate a transaction request. The terminal transaction circuit 136 then transmits the transaction request to the card network computing system 210 over the network 160 via the terminal network circuit 132. The token management circuit 216 receives the transaction request and cooperates with the token vault 218 to detokenize the payment token into a PAN. The token management circuit 216 then includes detokenized payment token information in the transaction request, and transmits the transaction request to the financial institution computing system 140 over the network 160 via the CN network circuit 212.

The FI transaction circuit 148 at the financial institution computing system 140 receives the transaction request via the FI network circuit 150. The FI transaction circuit 148 cooperates with the customer database 146 and the FI user activity circuit 142 to authenticate the transaction request using the activity data of the user, performs a plurality of fraud checks, and determines whether the requested transaction may properly be completed. The FI transaction circuit 148 authorizes the requested transaction, and transmits a confirmation to be received at the terminal transaction circuit 136 over the network 160 (e.g., via the card network computing system 210). The terminal transaction circuit 136 may cause the terminal I/O 138 to provide the user or a clerk with a visual representation of the confirmation (e.g., a screen on a display, a printed receipt, etc.).

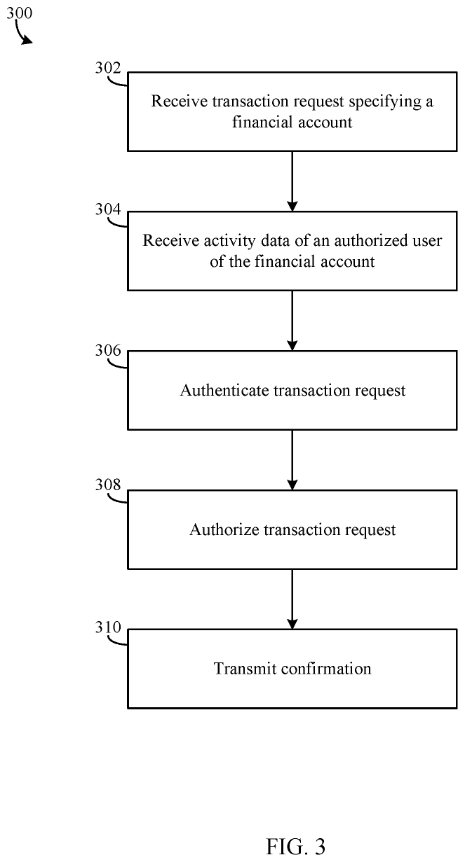

Referring now to FIG. 3, a flowchart of a method 300 of authorizing payment transactions is shown according to an example embodiment. The method 300 may be performed by processing and storage hardware on a financial institution computing system (e.g., the financial institution computing system 140), as executed by one or more logics comprising one or more software applications configured to perform the functions described below.

At step 302, a transaction request is received. The transaction request is received by a FI transaction circuit (e.g., the FI transaction circuit 148), over a network (e.g., the network 160) via a network circuit (e.g., the FI network circuit 450). In various embodiments, the transaction request includes payment credentials and authentication information corresponding to an authorized user of a financial account. The transaction request is created at a transaction terminal (e.g., the transaction terminal 130) after receiving a request to conduct a transaction from a customer. The transaction terminal creates the transaction request using the transaction information (e.g., including characteristics of the transaction request such as merchant information, a transaction amount, etc.), and transmits the transaction request over the network.

At step 304, activity data is received. The activity data is received by a FI user activity circuit (e.g., the FI user activity circuit 142), over a network (e.g., the network 160) via a network circuit (e.g., the FI network circuit 450). The activity data is indicative of an activity of an authorized user of the financial account specified in the transaction request. In some embodiments, the FI user activity circuit receives the activity data from the user computing device 120 or the monitoring device 110. The user computing device 120 may be a device associated with the authorized user, such a smartphone or other computing device. The monitoring device 110 may be associated with the authorized user or may be configured to acquire activity data for a plurality of individuals in addition to the authorized user of the financial account. In some embodiments, the FI user activity circuit 142 is configured to determine an expected activity of a user based on a characteristic of the transaction request.

At 306, the transaction request is authenticated. In some embodiments, the FI transaction circuit authenticates the transaction request using the activity data by determining that the activity data is indicative of an expected activity associated with a characteristic of the transaction request. The characteristic of the transaction request may include a location of the transaction terminal, a time of day when the FI transaction circuit receives the transaction request, a day of the week when the FI transaction circuit receives the transaction request, a type of merchant associated with the transaction terminal, a type of transaction, a type of good purchased, and a type of service purchased. The FI transaction circuit may authenticate the transaction request using additional information stored in a customer database (e.g., the customer database 146) maintained at the financial institution computing system.

At 308, the transaction request is authorized. The FI transaction circuit may authorize the transaction request after performing one or more checks to determine that the transaction request was not fraudulently made and that the underlying transaction may otherwise be properly completed. In one embodiment, the FI transaction circuit cooperates with the customer database to determine whether the financial account contains sufficient funds to complete the transaction request. If the FI transaction circuit finds that no fraud indicators are present and that the transaction request may properly be made, the FI transaction circuit may authorize the transaction request (e.g., by causing funds from the financial account associated with the PAN to transfer to a merchant account). Alternatively, if the FI transaction circuit finds one or more fraud indicators, and/or that the transaction request cannot be properly made, the FI transaction circuit may deny the transaction request.

At 310, a confirmation is transmitted. The FI transaction circuit may prepare the confirmation to include information relating to whether the transaction request was authorized or was not authorized. The FI transaction circuit transmits the confirmation over the network to the transaction terminal, which in some embodiments routes the confirmation to a device associated with the authorized user (e.g., a mobile device or the user computing device 120).

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

1. A financial institution computing system, the system comprising:
a network circuit enabling the financial institution computing system to exchange information over a network;
a customer database storing financial information for a plurality of customers;
a user activity circuit configured to receive, over the network via the network circuit, a plurality of activity data indicative of one or more user activities during a predetermined time period associated with a transaction request, the plurality of activity data including first activity data and second activity data; and
a transaction circuit configured to:
receive, over the network via the network circuit, the transaction request specifying the financial account;
receive, from the user activity circuit, activity profile data associated with the financial account, wherein the activity profile data comprises historical biometric data, location data, and transactional data;
determine one or more transaction characteristics representative of the received transaction request;
receive, from the user activity circuit, the first activity data acquired by a sensor contained by an internet enabled device located at an origination point of the transaction request, wherein the first activity data comprises first current data points for the same or similar data categories as the activity profile data;
receive, from the user activity circuit, the second activity data acquired by a sensor contained by an internet enabled device located at premises associated with the user, wherein the second activity data comprises second current data points for the same or similar data categories as the activity profile data;
identify one or more expected user activities associated with the transaction characteristics representative of the received transaction request, wherein the one or more expected user activities are based on the activity profile data previously obtained in conjunction with a previous transaction request having at least one characteristic that corresponds to at least one of the transaction characteristics representative of the received transaction request;
analyze the first activity data, the second activity data, and the one or more expected user activities by determining that both of the first activity data and the second activity data is congruent with the one or more expected user activities, and by verifying neither the first activity data nor the second activity data contain an irreconcilable data point;
authenticate, in response to determining that both of the first activity data and the second activity data is congruent with the identified one or more expected user activities and verifying neither the first activity data nor the second activity data contain an irreconcilable data point, the transaction request;
authorize the transaction request based at least in part on whether the transaction request is authenticated and information in the customer database; and
transmit a confirmation to a transaction terminal over the network via the network circuit.

2. The financial institution computing system of claim 1, wherein at least one of the one or more transaction characteristics representative of the transaction request includes at least one of a location of the transaction terminal, a time of day when the transaction circuit receives the transaction request, a day of the week when the transaction circuit receives the transaction request, a type of merchant associated with the transaction terminal, a type of transaction, a type of good purchased, and a type of service purchased.

3. (canceled)

4. The financial institution computing system of claim 1, wherein the activity profile data is associated with an authorized user stored in the customer database.

5. The financial institution computing system of claim 1, wherein the plurality of activity data is indicative of at least one user activity performed concurrent with the financial transaction request.

6. The financial institution computing system of claim 1, wherein the plurality of activity data is indicative of at least one user activity performed prior to the financial transaction request.

7. The financial institution computing system of claim 1, wherein the user activity circuit is configured to receive the plurality of activity data from at least one of a user computing device associated with an authorized user and a monitoring device.

8. The financial institution computing system of claim 7, wherein the at least one of the user computing device and the monitoring device include a sensing device configured to acquire the plurality of activity data and a input/output circuit configured to cause the acquired activity to be transmitted to at least one of the transaction circuit and the user activity circuit.

9. The financial institution computing system of claim 1, wherein the plurality of activity data is indicative of a physical activity of the user, and wherein the physical activity includes at least one of walking, running, sitting, standing, sleeping, breathing, and eating.

10. A method of authorizing a transaction request performed by a financial institution computing system, the method comprising:
receiving, by a transaction circuit over a network via a network circuit, a transaction request specifying a financial account;
receiving, by a user activity circuit over the network via the network circuit, activity profile data associated with the financial account, wherein the activity profile data comprises historical biometric data, location data, and transactional data;
determining one or more transaction characteristics representative of the received transaction request;
receive, by the user activity circuit, a first activity data acquired by a plurality of sensors contained by a plurality of internet enabled devices located at an origination point of the transaction request, wherein the first activity data comprises current data points for the same or similar data categories as the activity profile data;
receive, by the user activity circuit, a second activity data acquired by a plurality of sensors contained by a plurality of internet enabled devices located at premises associated with the user, wherein the second activity data comprises current data points for the same or similar data categories as the activity profile data;
identifying one or more expected user activities associated with the transaction characteristics representative of the received transaction request, wherein the one or more expected user activities are based on the activity profile data previously obtained in conjunction with a previous transaction request having at least one characteristic that corresponds to at least one of the transaction characteristics representative of the received transaction request;
analyze the first activity data, the second activity data, and the one or more expected user activities by determining that both of the first activity data and the second activity data is congruent with the one or more expected user activities, and by verifying neither the first activity data nor the second activity data contain an irreconcilable data point;
authenticating, by the transaction circuit and in response to determining that both of the first activity data and the second activity data is congruent with the identified one or more expected user activities and verifying neither the first activity data nor the second activity data contain an irreconcilable data point, the transaction request;
authorizing, by the transaction circuit, the transaction request based at least in part on whether the transaction request is authenticated and information in the customer database; and
transmitting, by the transaction circuit via the network circuit, a confirmation to a transaction terminal over the network via the network circuit.

11. The method of claim 10, wherein at least one of the one or more transaction characteristics representative of the transaction request includes at least one of a location of the transaction terminal, a time of day when the transaction circuit receives the transaction request, a day of the week when the transaction circuit receives the transaction request, a type of merchant associated with the transaction terminal, a type of transaction, a type of good purchased, and a type of service purchased.

12. (canceled)

13. The method of claim 10, wherein the activity profile data is associated with an authorized user stored in the customer database.

14. The method of claim 10, wherein the plurality of activity data is indicative of at least one user activity performed concurrent with or prior to the financial transaction request.

15. The method of claim 10, wherein the plurality of activity data is received from at least one of a user computing device associated with an authorized user and a monitoring device, and wherein the at least one of the user computing device and the monitoring device acquire the activity data and transmit the activity data to at least one of the transaction circuit and the user activity circuit.

16. A non-transitory computer readable media having computer-executable instructions embodied therein that, when executed by a transaction circuit of a financial institution computing system, causes the financial institution computing system to perform operations to authorize transaction requests, the operations comprising:
receive, over a network via a network circuit, a transaction request specifying a financial account;
receive, by a user activity circuit over the network via the network circuit, activity profile data associated with the financial account, wherein the activity profile data comprises historical biometric data, location data, and transactional data;
determine one or more transaction characteristics representative of the received transaction request;
receive, from the user activity circuit, a first activity data acquired by a plurality of sensors contained by a plurality of internet enabled devices located at an origination point of the transaction request, wherein the first activity data comprises current data points for the same or similar data categories as the activity profile data;
receive, from the user activity circuit, a second activity data acquired by a plurality of sensors contained by a plurality of internet enabled devices located at premises associated with the user, wherein the second activity data comprises current data points for the same or similar data categories as the activity profile data;
identify one or more expected user activities associated with the transaction characteristics representative of the received transaction request, wherein the one or more expected user activities are based on the activity profile data previously obtained in conjunction with a previous transaction request having at least one characteristic that corresponds to at least one of the transaction characteristics representative of the received transaction request;
analyze the first activity data, the second activity data, and the one or more expected user activities by determining that both of the first activity data and the second activity data is congruent with the one or more expected user activities, and by verifying neither the first activity data nor the second activity data contain an irreconcilable data point;
authenticate, in response to determining that both of the first activity data and the second activity data is congruent with the identified one or more expected user activities and verifying neither the first activity data nor the second activity data contain an irreconcilable data point, the transaction request;
authorize the transaction request based at least in part on whether the transaction request is authenticated and information in the customer database; and
transmit, via the network circuit, a confirmation to a transaction terminal over the network.

17. The media of claim 16, wherein at least one of the one or more transaction characteristics representative of the transaction request includes at least one of a location of the transaction terminal, a time of day when the transaction circuit receives the transaction request, a day of the week when the transaction circuit receives the transaction request, a type of merchant associated with the transaction terminal, a type of transaction, a type of good purchased, and a type of service purchased.

18. (canceled)

19. The media of claim 16, wherein the activity profile data is associated with an authorized user stored in the customer database.

20. The media of claim 16, wherein the plurality of activity data is received from at least one of a user computing device associated with an authorized user and a monitoring device, and wherein the at least one of the user computing device and the monitoring device acquire the activity data and transmit the activity data to at least one of the transaction circuit and the user activity circuit.
